(19) United States
(12) Patent Application Publication
(10) Pub. No.: US 2024/0396266 A1
(43) Pub. Date: Nov. 28, 2024

(54) Connector and Device Comprising the Same

(71) Applicants: Tyco Electronics Holdings (Bermuda) No. 7 Limited, Hamilton (BM); Tyco Electronics (Shanghai) Co., Ltd., Shanghai (CN)

(72) Inventors: Hengkang Wu, Dongguan (CN); Zhaohai (Tim) Xue, Shanghai (CN); Xinjie (David) Zhang, Shanghai (CN); Ching Hsiang Chang, Taipei (TW)

(73) Assignees: Tyco Electronics Holdings (Bermuda) No. 7 Limited, Hamilton (BM); Tyco Electronics (Shanghai) Co., Ltd., Shanghai (CN)

(21) Appl. No.: 18/672,263

(22) Filed: May 23, 2024

(30) Foreign Application Priority Data
May 23, 2023 (CN) 202310587704.2

(51) Int. Cl. H01R 13/6471; H01R 13/424

(52) U.S. Cl. CPC H01R 13/6471; H01R 13/424

(57) ABSTRACT

A connector includes a housing, a row of terminals disposed in the housing, and a grounding member having a flat body extending across the row of terminals. The row of terminals has a pair of signal terminals and a pair of grounding terminals located on opposite sides of the pair of the signal terminals. The flat body at least partially covers the pair of signal terminals. The grounding member has a plurality of grounding arms extending from a plane of the flat body. Each of the grounding arms abuts against one of the grounding terminals.

### CROSS-REFERENCE TO RELATED APPLICATION

This application claims the benefit of the filing date under 35 U.S.C. § 119 (a)-(d) of Chinese Patent Application No. 202310587704.2, filed on May 23, 2023.

### FIELD OF THE INVENTION

The present disclosure relates to a connector and a device comprising the connector.

### BACKGROUND

A connector is a device used to connect two active devices to transmit current or signals. A connector may simplify an assembly process of electronic product and also simplify a mass production process of the electronic products. A connector is easy to repair, and if an electronic component fails, the failed component may be quickly replaced with a connector installed. With an advancement of technology, the electronic product equipped with a connector may use updated electronic components, replacing old electronic components with new and better performing ones for easy upgrading. A connector may enhance a flexibility of product design when designing and integrating a new product, as well as when composing a system with electronic components. Therefore, connectors are widely used in fields such as transportation, healthcare, aerospace, military, and home appliances.

The basic performances of a connector may be divided into three categories: mechanical performance, electrical performance, and environmental performance.

Insertion and extraction force and mechanical life are important mechanical performances. The insertion and extraction force and mechanical life of a connector are related to a structure of a contact (a magnitude of a positive pressure), a quality of a coating on a contact area (sliding friction coefficient), and an accuracy of a size of an arrangement of the contacts (alignment precision).

Main electrical performances of a connector comprise a contact resistance, an insulation resistance, and a dielectric strength. Among them, a high-quality electrical connector should have a low and stable contact resistance, which ranges from a few milliohms to tens of milliohms. An insulation resistance is an index that measures the insulation performance between the contacts of an electrical connector and between the contacts and a housing of the connector. An order of magnitude of the insulation resistance ranges from hundreds of megaohms to thousands of megaohms. Dielectric strength is an ability of a connector to withstand a rated test voltage between the contacts of the connector or between the contacts and the housing.

Environmental performance comprises a temperature resistance, a humidity resistance, a salt spray resistance, a vibration, and an impact resistance, etc.

The development of connector technology presents the following characteristics: high-speed and digitalization of signal transmission, integration of various signal transmissions, miniaturization of product volume, low cost of products, modular combination, convenience of insertion and extraction, and so on.

In existing connectors with at least one row of terminals, signal terminals of each row of terminals are usually exposed, resulting in signal interference between the signal terminals of each row of terminals, limiting an improvement of a signal integrity. Grounding terminal(s) located between the signal terminals of each row of terminals may not effectively shield the signal interference between adjacent signal terminals, further limiting the improvement of the signal integrity, and resulting in the existing connectors being unable to be used in areas with higher requirements for the signal integrity.

### SUMMARY

A connector includes a housing, a row of terminals disposed in the housing, and a grounding member having a flat body extending across the row of terminals. The row of terminals has a pair of signal terminals and a pair of grounding terminals located on opposite sides of the pair of the signal terminals. The flat body at least partially covers the pair of signal terminals. The grounding member has a plurality of grounding arms extending from a plane of the flat body. Each of the grounding arms abuts against one of the grounding terminals.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein:

FIG. 1 is a perspective view of a connector according to an embodiment of the present disclosure;

FIG. 2 is a side view of a row of first terminals and a row of second terminals for a connector according to an embodiment of the present disclosure;

FIG. 3 is a perspective view of the row of the first terminals located above in the two rows of terminals in FIG. 2;

FIG. 4 is a perspective view of the row of the second terminals located below in the two rows of terminals in FIG. 2;

FIG. 5 is a perspective view of the third grounding member respectively installed on the row of the first terminals in FIG. 3 and the row of the second terminals in FIG. 4;

FIG. 6 is a perspective view of the first grounding member installed on the row of the second terminals in FIG. 4;

FIG. 7 is a side view of two rows of terminals installed with the connecting member in FIG. 2;

FIG. 8 is a perspective view of the connecting member in FIG. 7;

FIG. 9 is a bottom view of the connecting member connected between the second grounding member and the third grounding member in FIG. 7;

FIG. 10 is a bottom view of the row of the first terminals installed with the connecting member in FIG. 7, and for clarity, a first connecting portion of the connecting member is omitted;

FIG. 11 is a side view of two row of third terminals for a connector according to an embodiment of the present disclosure;

FIG. 12 is a perspective view of one row of the third terminals in FIG. 11;

FIG. 13 is a side view of the first and second rows of terminals for a connector according to an embodiment of the present disclosure; and

FIG. 14 is a perspective view of the row of the second terminals in FIG. 13.

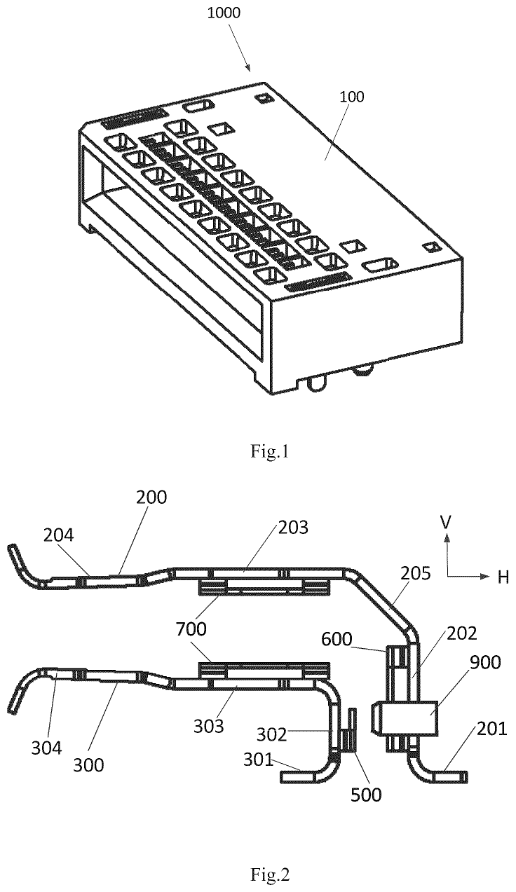

### DETAILED DESCRIPTION OF EXEMPLARY EMBODIMENTS

The features in this disclosure will become more apparent in the following detailed description in conjunction with the accompanying drawings, where similar reference numerals identify corresponding components. In the accompanying drawings, similar reference numerals typically represent identical, functionally similar, and/or structurally similar components. Unless otherwise stated, the drawings provided throughout the entire disclosure should not be construed as drawings drawn to scale.

In order to make the purpose, technical scheme, and advantages of the present disclosure clearer, the following is a detailed explanation of the present disclosure, combined with specific embodiments and referring to the attached drawings. However, it should be understood that these descriptions are only illustrative and not intended to limit the scope of the present disclosure. In the following detailed description, for case of interpretation, many specific details are elaborated to provide a comprehensive understanding of the embodiments of the present disclosure. However, it is evident that one or more embodiments may also be implemented without these specific details. In addition, in the following explanation, the description of the well-known technology is omitted to avoid unnecessary confusion with the concept of the present disclosure.

The terms used here are only for describing specific embodiments and are not intended to limit the present disclosure. The term “comprising” used here indicates the existence of features, steps, and operations, but does not exclude the existence or addition of one or more other features.

In the case of using expressions such as “at least one of A, B, and C, etc.” or the like, it should generally be interpreted in accordance with the meaning of the expressions that those skilled in the art usually understand (for example, “a system with at least one of A, B, and C” should comprise but not be limited to a system with only A, a system with only B, a system with only C, a system with A and B, a system with A and C, a system with B and C, and/or a system with A, B, C, etc.).

All terms used here (comprising technical and scientific terms) have the meanings commonly understood by those skilled in the art, unless otherwise defined. It should be noted that the terms used here should be interpreted as having a meaning consistent with the context of this specification and should not be interpreted in an overly rigid manner.

The present disclosure discloses a connector 1000 and a device comprising the connector 1000. The connector 1000 comprises a housing 100, at least one row of terminals 200, 300, 400, and at least one grounding member 500, 600, 700. The at least one row of terminals 200, 300, and 400 are installed in the housing 100 respectively, and each row of terminals 200, 300, and 400 has at least one pair of signal terminals 210, 310, 410, and grounding terminals 220, 320, and 420 located on two opposite sides of each pair of the signal terminals 210, 310, 410. The at least one grounding member 500, 600, 700 has a flat body 510, 610, 710 extending across the at least one row of terminals 200, 300, 400 to at least partially cover the at least one pair of the signal terminals 210, 310, 410, and a plurality of grounding arms 520, 620, 720 extending from a plane of the body 510, 610, 710, wherein each of the plurality of grounding arms 520, 620, 720 abuts against each corresponding one of the grounding terminals 220, 320, 420.

The flat body 510, 610, and 710 that at least partially covers the at least one pair of signal terminals 210, 310, 410 not only greatly shields electromagnetic waves radiated by the covered signal terminals 210, 310, and 410 to the outside (i.e. signal interference), but also greatly shields influence of external electromagnetic waves on the covered signal terminals 210, 310, and 410 (i.e. signal interference), effectively improving a signal integrity of the connector 1000.

Each of the grounding arms 520, 620, and 720 extending from the same body 510, 610, and 710 of the grounding member 500, 600, and 700 is abutted against each corresponding one of the grounding terminals 220, 320, and 420, further effectively shielding the interference between adjacent two pairs of signal terminals 210, 310, and 410 located on two opposite sides of each of the grounding terminals 220, 320, and 420, shortening a signal return path of the connector 1000 and further improving the signal integrity of connector 1000.

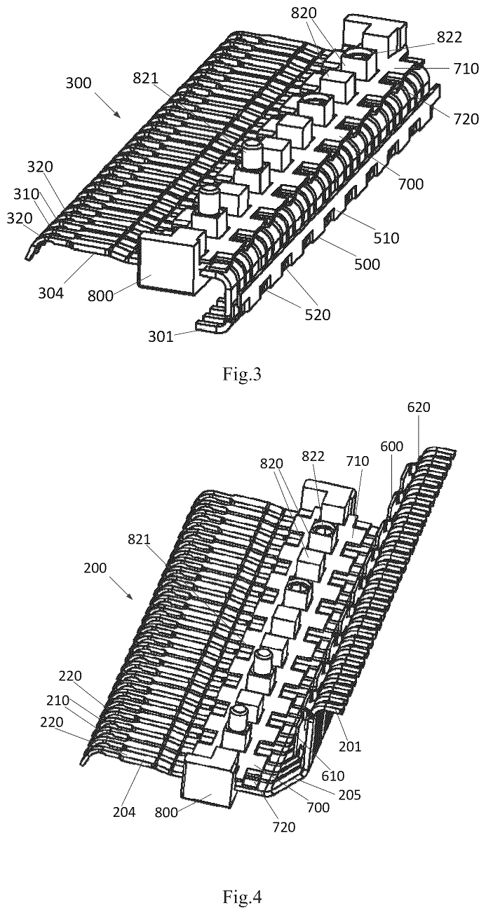

Referring to FIGS. 3, 4, 10, 12, and 14, the connector 1000 further comprises a holding member 800 installed in the housing 100, each row of terminals of the at least one row of terminals 200, 300, and 400 are provided on one said holding member 800, thereby fixing relative positions between the terminals in each row of the terminals 200, 300, and 400.

The holding member 800 comprises at least one first holding portion 810 and at least one pair of second holding portions 820 respectively located on two opposite sides of each first holding portion 810 and protruding beyond the first holding portion 810. Each pair of the signal terminals 210, 310, and 410 extend through the first holding portion 810. Each of the grounding terminals 220, 320, and 420 extends through each corresponding one of the second holding portions 820.

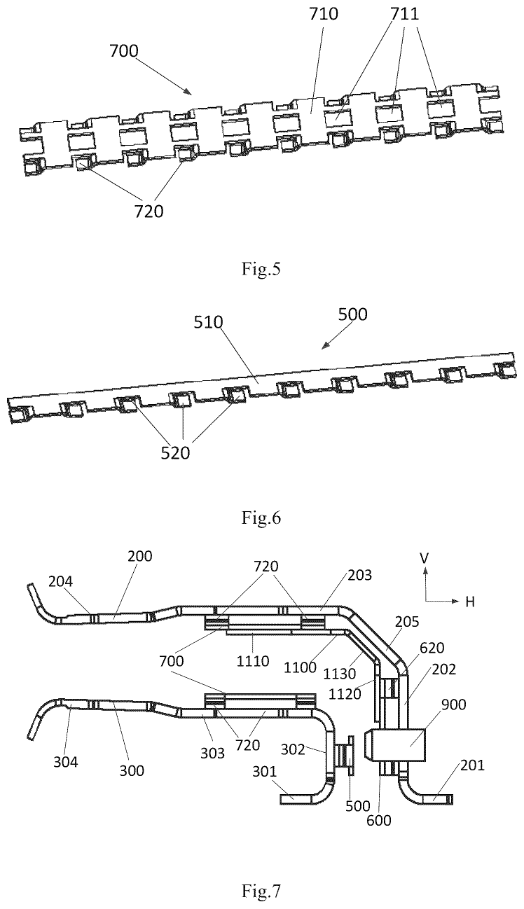

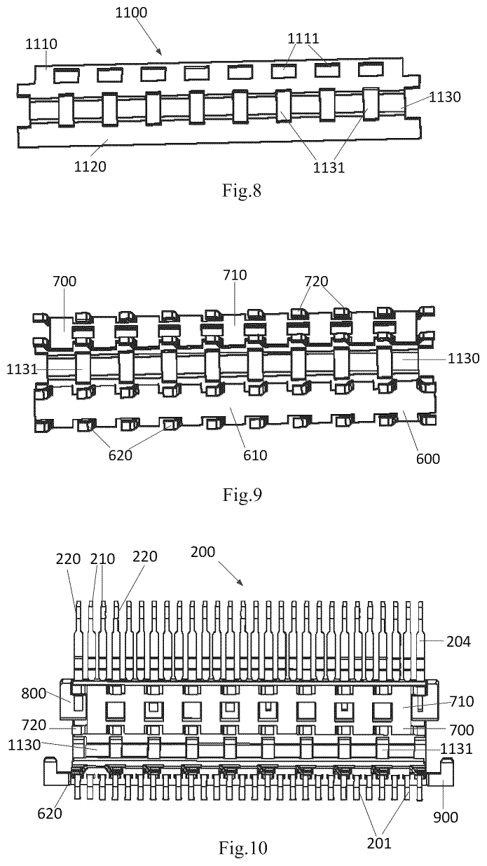

Referring to FIGS. 2 to 10 and 13 to 14, the two rows of terminals 200 and 300 according to the first embodiment of the present disclosure are described, namely, the row of the first terminals 200 and a row of second terminals 300, which are located below, aligned with, and separated from the row of the first terminals 200, respectively. The two holding members 800 respectively installed on two rows of the terminals 200 and 300 are respectively provided with at least one of a protrusion 821 and a recess 822 that may be matched with and connected to each other on their respective second holding portions 820, so that two said holding members 800 may be assembled with each other together, thereby assembling the row of the first terminals 200 with the row of the second terminals 300 together.

Each first terminal of the row of the first terminals 200, as shown in FIG. 2, has a first section 201, a second section 202, a third section 203, a fourth section 204, and a connecting section 205. The first section 201 extends in a horizontal direction H. The second section 202 extends in a vertical direction V upwards from the first section 201. The third section 203 extends in the horizontal direction H away from the first section 201. The fourth section 204 extends obliquely from the third section 203 towards the row of the second terminals 300. The connecting section 205 is obliquely connected between the second section 202 and the third section 203.

Each second terminal of the row of the second terminals 300, as shown in FIG. 2, has a first portion 301, a second portion 302, a third portion 303, and a fourth portion 304. The first portion 301 extends in a horizontal direction H away from the first section 201 and is coplanar with the first section 201, so that the first portion 301 and the first section 201 are respectively abutted against electrodes of a circuit board to be connected. The second portion 302 extends in the vertical direction V upwards from the first portion 301. The third portion 303 extends in the horizontal direction H from the second portion 302 away from the first section 201. The fourth portion 304 extends obliquely from the third portion 303 towards the row of the first terminals 200 to form a horn-shaped free end together with the fourth section 204, making it easier to be inserted into a paired connector.

At least one grounding member according to an embodiment of the present disclosure comprises a first grounding member 500, a second grounding member 600, and a third grounding member 700.

Referring to FIGS. 2 to 3, 6 to 7, 13 to 14, the first grounding member 500 and an arrangement of the first grounding member 500 on the row of the first terminals 200 and the row of the second terminals 300 according to the embodiment of the present disclosure are described. The first grounding member 500 has a flat first body 510 and a plurality of separate first grounding arms 520 provided on and along one of two opposite side edges of the first body 510.

Here, the expression “separate” indicates that, except roots of the first grounding arms 520 extending from one of the side edges of the first body 510 being connected to that side edge respectively, no other parts of the first grounding arms 520 are connected to the first grounding member 500, that is, only the roots of the first grounding arms 520 are connected to the first grounding member 500.

By stamping the flat first body 510, the plurality of separate first grounding arms 520 are formed, which simplifies a production process of the first grounding member 500 and reduces production costs of the first grounding members 500. In addition, due to the plurality of first grounding arms 520 provided on and along only one side edge of the first body 510, the first body 510 may be constructed to be narrower.

Referring to FIG. 2, due to a short length of the second portion 302, the second portion 302 is not suitable to be provided with a second grounding member 600 as described below. Therefore, one narrower first grounding member 500 is provided on the second portions 302 of the row of the second terminals 300, so that the plurality of first grounding arms 520 are respectively abutted against each corresponding one of the grounding terminals in the vicinity of a connecting point between the first portion 301 and the second portion 302.

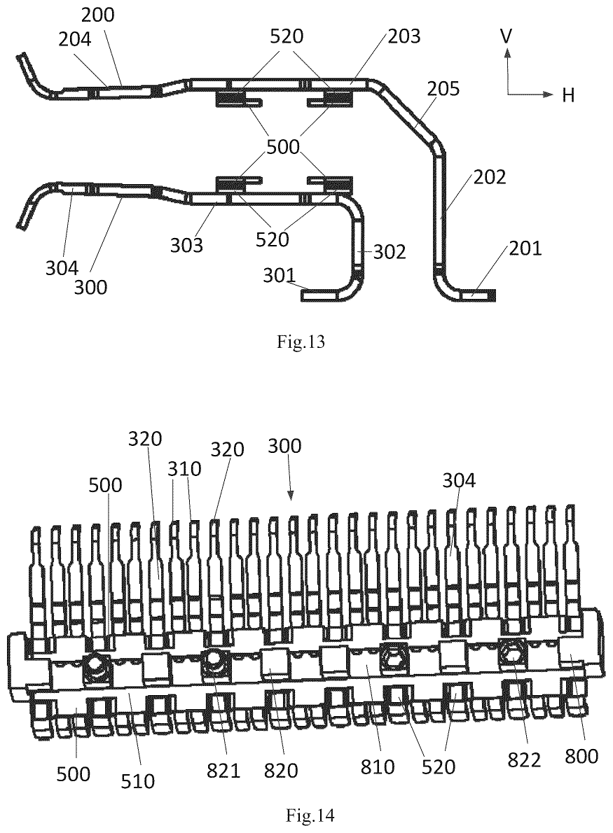

Referring to the embodiment shown in FIGS. 13 and 14, another two first grounding members 500 are respectively provided on two opposite sides of each of the second holding portions 820 of each of the holding members 800 on the row of the first terminals 200 and the row of the second terminals 300, so that the side edge, which is not provided with the first grounding arms 520, of one of the another two first grounding members 500 is abutted against one side of each of the second holding portions 820, and the side edge, which is not provided with the first grounding arms 520, of the other of the another two first grounding members 500 is abutted against the opposite side of each of the second holding portions 820, and the plurality of first grounding arms 520 of one of the another two first grounding members 500 located on the row of the second terminals 300 are respectively abutted against each corresponding one of the grounding terminals in the vicinity of the connecting point between the second portion 302 and the third portion 303. Another two first grounding members 500 located on the row of the first terminals 200 and another two first grounding members 500 located on the row of the second terminals 300 are aligned with each other in the vertical direction V respectively (see FIG. 13).

Referring to FIGS. 2, 4, 7, and 9, a second grounding member 600 according to an embodiment of the present disclosure is described, which comprises a flat second body 610 and a plurality of separate second grounding arms 620 respectively provided on and along two opposite side edges of the second body 610. The second grounding member 600 is provided on the second section 202 of each first terminal of the row of the first terminals 200, so that the plurality of second grounding arms 620 provided on and along one of the side edges of the second body 610 are respectively abutted against each corresponding one of the grounding terminals and aligned with the plurality of first grounding arms 520 in the vicinity of a connecting point between the first section 201 and second section 202.

Here, the expression “separate” indicates that, except roots of the second grounding arms 620 respectively extending from the two opposite side edges of the second body 610 being connected to the corresponding side edges, no other parts of the second grounding arms 620 are connected to the second grounding member 600, that is, only the roots of the second grounding arms 620 are connected to the second grounding member 600. By stamping the flat second body 610, the plurality of separate second grounding arms 620 are formed, which simplifies a production process of the second grounding member 600 and reduces production costs of the second grounding member 600.

Because the row of the first terminals 200 are very long, in order to better secure the row of the first terminals 200, a fixing member 900 is provided on the second section 202 of each first terminal of the row of the first terminals 200 across the row of the first terminals 200. The second grounding member 600 is covered by the fixing member 900 (see FIGS. 2, 7, 9, and 10).

Referring to FIGS. 2 to 5 and 7 to 10, a third grounding member 700 according to an embodiment of the present disclosure is described, which comprises a flat third body 710 and a plurality of separate third grounding arms 720 respectively provided on and along two opposite side edges of the third body 710, wherein a through hole 711 is provided in the third body 710 between two third grounding arms 720 respectively located on the two opposite side edges of the third body 710 and aligned with each other. The through hole 711 makes it easy to provide one third grounding member 700 on each holding member 800, as described below.

Here, the expression “separate” indicates that, except that roots of the third grounding arms 720 respectively extending from the two opposite side edges of the third body 710 being connected to the corresponding side edges, no other parts of the third grounding arms 720 are connected to the third grounding member 700, that is, only the roots of the third grounding arms 720 are connected to the third grounding member 700. By stamping the flat third body 710, the plurality of separate third grounding arms 720 and through holes 711 are formed, which simplifies a production process of the third grounding member 700 and reduces production costs of the third grounding member 700.

In the embodiment shown in FIG. 2, one third grounding member 700 is provided on each holding member 800, so that each of the second holding portions 820 protrudes from each corresponding one of the through holes 711 and the plurality of third grounding arms 720 of the third grounding member 700 located on the row of the second terminals 300 provided on and along one of the side edges of the third body 710 are respectively abutted against each corresponding one of the grounding terminals in the vicinity of the connecting point between the second portion 302 and third portion 303, wherein the third grounding member 700 located on the row of the first terminals 200 and the third grounding member 700 located on the row of the second terminals 300 are aligned with each other in the vertical direction V.

In order to further enhance an ability to improve signal integrity, a connecting member 1100 is provided between the second grounding member 600 and the third grounding member 700 (see FIGS. 7 to 10). The connecting member 1100 includes a flat first connecting portion 1110, a flat second connecting portion 1120, and a flat third connecting portion 1130. The first connecting portion 1110 is used to cover the third grounding member 700 located on the row of the first terminals 200 and is provided with a plurality of alignment holes 1111 configured for respectively aligning with the through holes 711 of the third grounding member 700. The second connecting portion 1120 is used to cover the second grounding member 600 located on the row of the first terminals 200. The third connecting portion 1130 is connected between the first connecting portion 1110 and the second connecting portion 1120 at an angle relative to the first connecting portion 1110 and the second connecting portion 1120 and covers the connecting sections 205 of the row of the first terminals 200 and is separated from the connecting sections 205 (see FIG. 7). The third connecting portion 1130 is provided with a plurality of release holes 1131 extending between the first connecting portion 1110 and the second connecting portion 1120 to release stress inside the bent connecting member 1100.

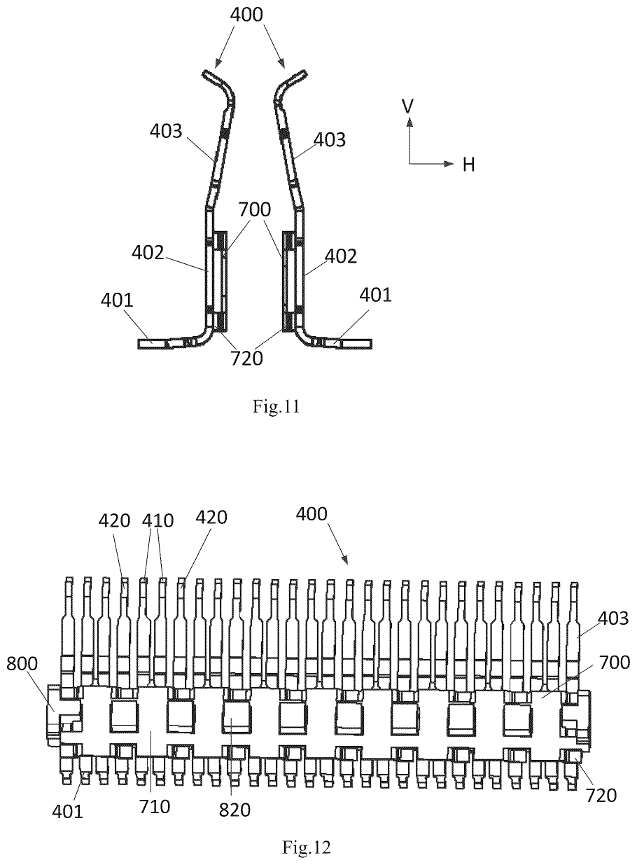

Referring to FIGS. 11 to 12, two rows of terminals 400 according to the second embodiment of the present disclosure are described, that is, two rows of third terminals 400 that are in mirror symmetry, aligned with and separated from each other. The two holding members 800 respectively installed on the two rows of third terminals 400 are respectively provided with at least one of the protrusion 821 and recess 822 that may be matched with and connected to each other on their respective second holding portions 820, so that the two holding members 800 may be assembled together, thereby assembling the two rows of the third terminals 400 together.

Each third terminal of the two rows of the third terminals 400 comprises a first segment 401, a second segment 402, and a third segment 403.

The first segment 401 of each third terminal 400 of one of the rows of the third terminals 400 extends in the horizontal direction H to be abutted against the electrodes of the circuit board to be connected. The second segment 402 extends in the vertical direction V upwards from the first segment 401. The third segment 403 extends obliquely from the second segment 402 away from the first segment 401, so as to form a horn-shaped free end together with the third segment 403 of each third terminal of the other opposite row of the third terminals 400, thus the two rows of the third terminals 400 are easy to be inserted into a paired connector.

Continuing with reference to FIGS. 11 to 12, one third grounding member 700 is provided on each of the holding members 800 (for clarity, holding member 800 is not shown in FIG. 11) on the two rows of the third terminals 400, so that each of the second holding portions 820 protrudes from each corresponding one of the through holes 711 and the plurality of third grounding arms 720 provided on and along one of the side edges of the third body 710 respectively are abutted against each corresponding one of the grounding terminals in the vicinity of the connecting point between the first segment 401 and second segment 402, wherein two third grounding members 700 respectively located on the two rows of the third terminals 400 are aligned with each other in the horizontal direction H.

However, the present disclosure is not limited to this, and two first grounding members 500 may be provided on each of the holding members 800 in the embodiment of FIGS. 11 to 12, or two first grounding members 500 may be provided on one of the holding members 800, and one third grounding member 700 may be provided on the other of the holding members 800.

It should be noted that the implementation not shown or described in the accompanying drawings, or the text of the specification are all forms known to the person skilled in the art that the present disclosure pertains to and have not been explained in detail. In addition, the above definitions of each of the components are not limited to the various specific structures, shapes, or methods mentioned in the embodiments, which may be easily modified or replaced by the person skilled in the art.

It should also be noted that in specific embodiments of the present disclosure, unless otherwise expressly stated, the numerical parameters in this specification and the attached claims are approximate values that may be changed based on the desired characteristics obtained by the content of the present disclosure. Specifically, all numbers used in the specification and claims to represent the dimensions, range conditions, etc. of the composition should be understood as being modified by the term “approximately” in all cases. In general, the meaning of the expression refers to an inclusion of a specific number of +10% changes in some embodiments, +5% changes in some embodiments, +1% changes in some embodiments, and +0.5% changes in some embodiments.

The person skilled in the art may understand that the features recorded in various embodiments and/or claims of the present disclosure may be combined or incorporated in a plurality of ways, even if such combinations or incorporations are not explicitly recorded in the present disclosure. Specifically, without departing from the spirit and teachings of the present disclosure, the features recorded in various embodiments and/or claims of the present disclosure may be combined and/or incorporated in a plurality of ways. All these combinations and/or incorporations fall within the scope of the present disclosure.

The specific embodiments described above provide further detailed explanations of the purpose, technical scheme, and beneficial effects of the present disclosure. It should be understood that the above explanations are only specific embodiments of the present disclosure and are not intended to limit the present disclosure. Any modifications, equivalent replacements, improvements, etc. made within the spirit and principles of the present disclosure should be comprised in the protection scope of the present disclosure.

What is claimed is:

1. A connector, comprising:
a housing;
a row of terminals disposed in the housing, the row of terminals has a pair of signal terminals and a pair of grounding terminals located on opposite sides of the pair of the signal terminals; and
a grounding member having a flat body extending across the row of terminals to at least partially cover the pair of signal terminals, the grounding member has a plurality of grounding arms extending from a plane of the flat body, each of the grounding arms abuts against one of the grounding terminals.

2. The connector according to claim 1, further comprising a holding member disposed in the housing, the row of terminals is disposed on the holding member, the holding member has:
a first holding portion through which the pair of the signal terminals extend; and
a pair of second holding portions disposed on opposite sides of the first holding portion and protruding beyond the first holding portion, each of the grounding terminals extends through one of the second holding portions.

3. The connector according to claim 2, wherein the row of terminals includes a row of first terminals and a row of second terminals located below, aligned with, and separated from the row of first terminals, each first terminal of the row of the first terminals has:
a first section extending in a horizontal direction;
a second section extending in a vertical direction upwards from the first section;
a third section extending in the horizontal direction away from the first section;
a fourth section extending obliquely from the third section towards the row of second terminals; and
a connecting section obliquely connected between the second section and the third section.

4. The connector according to claim 3, wherein each second terminal of the row of second terminals has:
a first portion extending in the horizontal direction away from the first section and coplanar with the first section;
a second portion extending in the vertical direction upwards from the first portion;
a third portion extending in the horizontal direction from the second portion away from the first section; and
a fourth portion extending obliquely from the third portion towards the row of first terminals.

5. The connector according to claim 4, wherein the grounding member has a first grounding member with a flat first body and a plurality of separate first grounding arms provided on and along one of a pair of opposite side edges of the flat first body.

6. The connector according to claim 5, wherein the first grounding member is disposed on the second portion of each second terminal of the row of second terminals, the first grounding arms each respectively abut against one of the grounding terminals in a vicinity of a connecting point between the first portion and the second portion.

7. The connector according to claim 5, wherein the grounding member has another pair of first grounding members respectively provided on opposite sides of each of the second holding portions of each of the holding members, the one of the pair of opposite side edges of the first flat body that is not provided with the first grounding arms of the each of the another pair of first grounding members abuts against a side of each of the second holding portions.

8. The connector according to claim 7, wherein the first grounding arms of one of the another pair of first grounding members that is disposed on the row of the second terminals respectively abut against each corresponding one of the grounding terminals in a vicinity of a connecting point between the second portion and the third portion.

9. The connector according to claim 8, wherein one of first grounding members is on the row of first terminals and is aligned in the vertical direction with one of first grounding members on the row of second terminals.

10. The connector according to claim 6, wherein the grounding member has a second grounding member with a flat second body and a plurality of second grounding arms disposed on and along a pair of opposite side edges of the flat second body.

11. The connector according to claim 10, wherein the second grounding member is disposed on the second section of each first terminal of the row of first terminals, the second grounding arms along one of the side edges of the flat second body each abut against one of the grounding terminals and are aligned with the first grounding arms in a vicinity of a connecting point between the first section and second section.

12. The connector according to claim 11, further comprising a fixing member on the second section of each first terminal of the row of first terminals across the row of first terminals, the second grounding member is covered by the fixing member.

13. The connector according to claim 10, wherein the grounding member has a third grounding member with a flat third body and a plurality of separate third grounding arms disposed on and along a pair of opposite side edges of the flat third body, a plurality of through holes are disposed in the flat third body between a pair of the third grounding arms aligned with each other and located on the opposite side edges of the flat third body.

14. The connector according to claim 13, wherein the third grounding member is provided on the holding member, each of the second holding portions protrudes from one of the through holes, the third grounding arms located on the row of second terminals provided on and along one of the opposite side edges of the flat third body each abut against one of the grounding terminals in a vicinity of a connecting point between the second portion and the third portion, the third grounding member on the row of first terminals and the third grounding member on the row of second terminals are aligned with each other in the vertical direction.

15. The connector according to claim 14, further comprising a connecting member including:
a flat first connecting portion covering the third grounding member on the row of first terminals, the flat first connecting portion has a plurality of alignment holes aligning with the through holes of the third grounding member;
a flat second connecting portion covering the second grounding member located on the row of first terminals; and
a flat third connecting portion connecting between the flat first connecting portion and the flat second connecting portion at an angle relative to the flat first connecting portion and the flat second connecting portion and covering the connecting sections of the row of first terminals, the flat third connecting portion has a plurality of release holes extending between the flat first connecting portion and the flat second connecting portion.

16. The connector according to claim 2, wherein the row of terminals includes two rows of third terminals that are in mirror symmetry, aligned with and separated from each other, each third terminal of the rows of the third terminals includes:
a first segment extending in a horizontal direction;
a second segment extending in a vertical direction upwards from the first segment; and
a third segment extending obliquely from the second segment away from the first segment.

17. The connector according to claim 16, wherein the grounding member includes a third grounding member with a flat third body and a plurality of separate third grounding arms disposed on and along a pair of opposite side edges of the flat third body, a plurality of through holes are disposed in the flat third body between a pair of the third grounding arms aligned with each other and located on the opposite side edges of the flat third body.

18. The connector according to claim 17, wherein the third grounding member is provided on the holding member, each of the second holding portions protrudes from one of the through holes, the third grounding arms located on the row of second terminals provided on and along one of the opposite side edges of the flat third body each abut against one of the grounding terminals in a vicinity of a connecting point between the first segment and the second segment, the third grounding member is one of a pair of third grounding members disposed on the two rows of third terminals that are aligned with each other in the horizontal direction.

19. The connector according to claim 2, wherein the holding member is one of a pair of holding members that are assembled together with a protrusion disposed on one of the holding members and a recess disposed on the other of the holding members.

20. A device, comprising:
a connector including a housing, a row of terminals disposed in the housing, the row of terminals has a pair of signal terminals and a pair of grounding terminals located on opposite sides of the pair of the signal terminals, and a grounding member having a flat body extending across the row of terminals to at least partially cover the pair of signal terminals, the grounding member has a plurality of grounding arms extending from a plane of the flat body, each of the grounding arms abuts against one of the grounding terminals.
